(19) United States
(12) Patent Application Publication
(10) Pub. No.: US 2024/0105379 A1
(43) Pub. Date: Mar. 28, 2024

(54) MAGNETIC COMPONENT AND METHOD OF MANUFACTURING MAGNETIC COMPONENT

(71) Applicant: CYNTEC CO., LTD., Hsinchu (TW)

(72) Inventors: Min-Feng Chung, Hsinchu (TW); Hao-Chun Chang, Hsinchu (TW); Tung-Cheng Chuang, Hsinchu (TW)

(73) Assignee: CYNTEC CO., LTD., Hsinchu (TW)

(21) Appl. No.: 18/227,295

(22) Filed: Jul. 27, 2023

Related U.S. Application Data
(60) Provisional application No. 63/409,828, filed on Sep. 25, 2022.

(51) Int. Cl. H01F 27/28; H01F 27/26; H01F 37/00; H01F 41/10

(52) U.S. Cl. CPC H01F 27/2828; H01F 27/263; H01F 37/00; H01F 41/10

(57) ABSTRACT

A magnetic component includes a core, a winding, a lead frame and a conductive material. The winding is disposed in the core. A winding end of the winding extends to an outer periphery of the core. The lead frame is disposed on the outer periphery of the core. At least one hole is formed on the lead frame and corresponds to the winding end. The conductive material is disposed in the at least one hole. The conductive material is in contact with the winding end.

### CROSS REFERENCE TO RELATED APPLICATIONS

This application claims the benefit of U.S. Provisional Application No. 63/409,828, filed on Sep. 25, 2022. The content of the application is incorporated herein by reference.

### BACKGROUND OF THE INVENTION

### 1. Field of the Invention

The invention relates to a magnetic component and a method of manufacturing the magnetic component and, more particularly, to a magnetic component capable of reducing direct current impedance and a method of manufacturing the magnetic component.

### 2. Description of the Related Art

When an inductor is used in a car to achieve noise suppression or buck-boost function, the reliability of the inductor will be severely tested. In order for this type of passive component to still be used in a circuit architecture of the car, a lead frame and a coil are generally connected by welding. Then, after a main body of the inductor is formed, an exposed portion of the lead frame is bent and formed. However, as the power of car increases recently, the characteristics required in a specific application have exceeded what this structure can afford. Therefore, inductor design with a higher level of reliability has to be derived and developed.

### SUMMARY OF THE INVENTION

The invention provides a magnetic component capable of reducing direct current impedance and a method of manufacturing the magnetic component, so as to solve the aforesaid problems.

According to an embodiment of the invention, a magnetic component includes a core, a winding, a lead frame and a conductive material. The winding is disposed in the core. A winding end of the winding extends to an outer periphery of the core. The lead frame is disposed on the outer periphery of the core. At least one hole is formed on the lead frame and corresponds to the winding end. The conductive material is disposed in the at least one hole. The conductive material is in contact with the winding end.

According to another embodiment of the invention, a method of manufacturing a magnetic component includes steps of forming a winding; disposing the winding in a core and extending a winding end of the winding to an outer periphery of the core; disposing a lead frame on the outer periphery of the core, wherein at least one hole is formed on the lead frame and corresponds to the winding end; and disposing a conductive material in the at least one hole, wherein the conductive material is in contact with the winding end.

As mentioned in the above, the invention forms at least one hole on the lead frame and disposes the lead frame on the outer periphery of the core, such that the winding end of the winding is exposed from the at least one hole. Then, the invention disposes the conductive material in the at least one hole to make the conductive material in direct contact with the winding end of the winding. Compared to conventional design connecting the lead frame and the coil by welding, the direct contact between the conductive material and the winding can avoid additional direct current resistance generated by the welding process and then greatly reduce direct current impedance, so as to achieve less power loss in high power application.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a perspective view illustrating a magnetic component according to an embodiment of the invention.

FIG. 2 is a flowchart illustrating a method of manufacturing the magnetic component shown in FIG. 1.

FIG. 3 is a perspective view illustrating a winding.

FIG. 4 is a perspective view illustrating a core including a first core member and a second core member.

FIG. 5 is a perspective view illustrating the winding shown in FIG. 3 being wound around a pillar of the first core member shown in FIG. 4.

FIG. 6 is a perspective view illustrating the pillar with the winding shown in FIG. 5 being disposed into the second core member shown in FIG. 4.

FIG. 7 is a perspective view illustrating a winding end of the winding shown in FIG. 6 extending to an outer periphery of the core.

FIG. 8 is a perspective view illustrating a lead frame disposed on the outer periphery of the core shown in FIG. 7.

FIG. 9 is a perspective view illustrating the core and the lead frame according to another embodiment of the invention.

FIG. 10 is a perspective view illustrating the core and the lead frame shown in FIG. 9 from another viewing angle.

FIG. 11 is a perspective view illustrating the core and the lead frame according to another embodiment of the invention.

### DETAILED DESCRIPTION

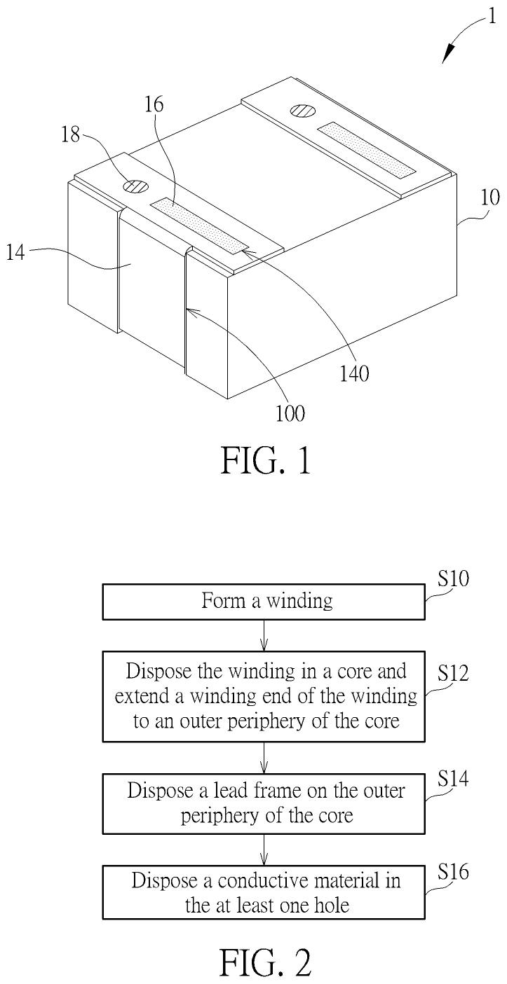

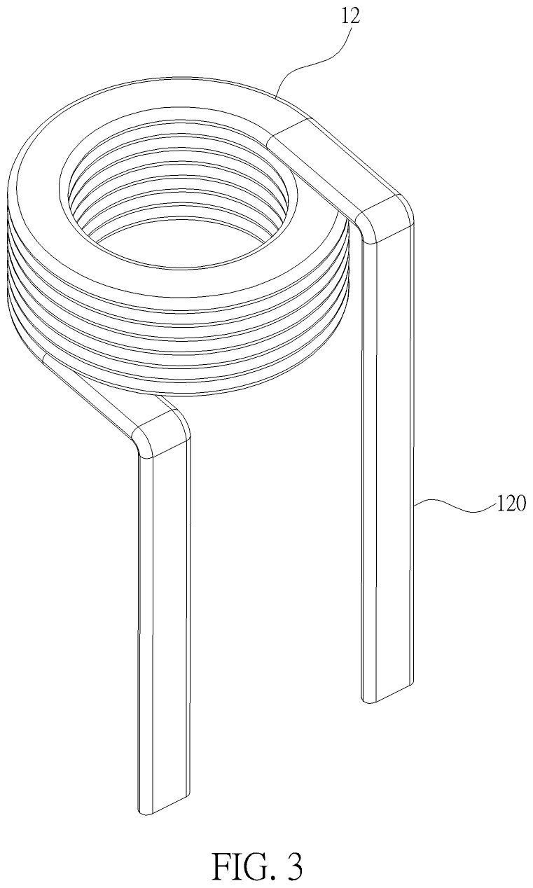

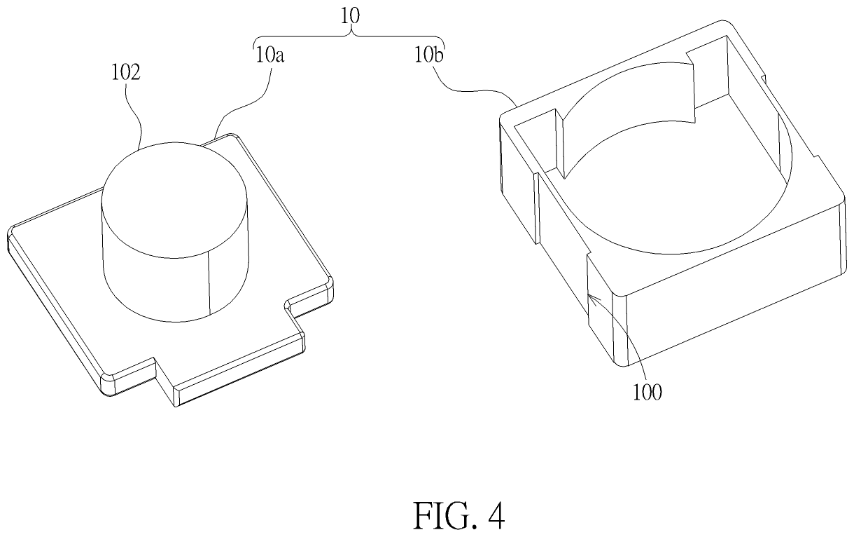

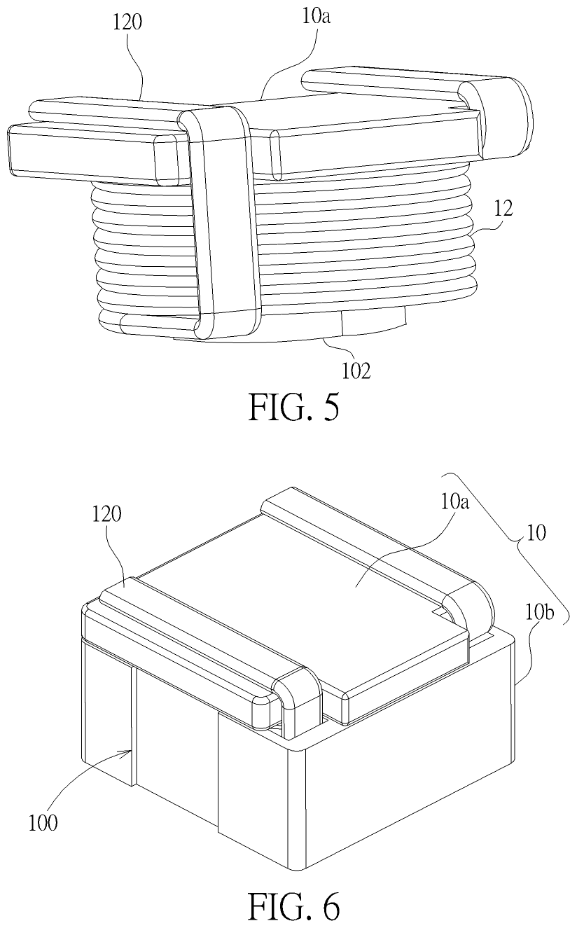

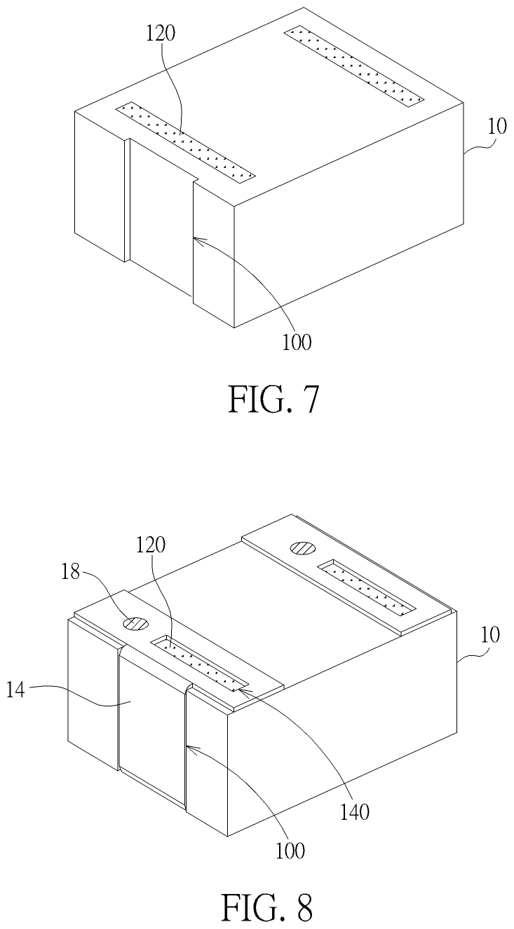

Referring to FIGS. 1 to 8, FIG. 1 is a perspective view illustrating a magnetic component 1 according to an embodiment of the invention, FIG. 2 is a flowchart illustrating a method of manufacturing the magnetic component 1 shown in FIG. 1, FIG. 3 is a perspective view illustrating a winding 12, FIG. 4 is a perspective view illustrating a core 10 including a first core member 10a and a second core member 10b, FIG. 5 is a perspective view illustrating the winding 12 shown in FIG. 3 being wound around a pillar 102 of the first core member 10a shown in FIG. 4, FIG. 6 is a perspective view illustrating the pillar 102 with the winding 12 shown in FIG. 5 being disposed into the second core member 10b shown in FIG. 4, FIG. 7 is a perspective view illustrating a winding end 120 of the winding 12 shown in FIG. 6 extending to an outer periphery of the core 10, and FIG. 8 is a perspective view illustrating a lead frame 14 disposed on the outer periphery of the core 10 shown in FIG. 7.

A magnetic component 1 shown in FIG. 1 is manufactured by a method shown in FIG. 2. FIGS. 3 to 8 show a process of manufacturing the magnetic component 1. In this embodiment, the magnetic component 1 may be, but is not limited to, an inductor.

To manufacture the magnetic component 1, first of all, step S10 shown in FIG. 2 is performed to form a winding 12 and a winding end 120 of the winding 12 that is bent, as shown in FIG. 3. In this embodiment, the winding 12 may be formed by a flat wire, but the invention is not so limited. Then, step S12 shown in FIG. 2 is performed to dispose the winding 12 in a core 10 and extend the winding end 120 of the winding 12 to an outer periphery of the core 10, as shown in FIGS. 4 to 6. In this embodiment, the core 10 may comprise a first core member 10a and a second core member 10b, as shown in FIG. 4. The first core member 10a may be a T core and the second core member 10b may be a U core. However, the types of the first core member 10a and the second core member 10b may be determined according to practical applications, so the invention is not limited to the embodiment shown in the figures. In this embodiment, to dispose the winding 12 in the core 10, step S12 may be performed to wind the winding 12 around a pillar 102 of the first core member 10a first and then bend the winding end 120 of the winding 12, as shown in FIG. 5. Then, step S12 may be further performed to dispose the pillar 102 with the winding 12 into the second core member 10b, as shown in FIG. 6. Furthermore, in step S12, some processes may be further performed according to practical applications, such as hot pressing, chamfer baking, coating, paint peeling, and so on, to form the core 10 with the winding end 120 extending to the outer periphery, as shown in FIG. 7.

Then, step S14 shown in FIG. 2 is performed to dispose a lead frame 14 on the outer periphery of the core 10. In this embodiment, a recess 100 may be formed on the outer periphery of the core 10 and the lead frame 14 may be embedded in the recess 100. Accordingly, the lead frame 14 may fit the core 10 tightly to improve vibration resistance and mechanical strength simultaneously. Furthermore, the lead frame 14 may be adhered to core 10 by glue to improve the connection strength between the lead frame 14 and the winding end 120 of the winding 12. Moreover, the lead frame 14 may be connected to the winding end 120 of the winding 12 by penetration welding. As shown in FIG. 8, there may be at least one penetration welding spot 18 formed on the lead frame 14. Since the lead frame 14 is directly welded to the winding end 120 of the winding 12 by penetration welding, the connection strength between the lead frame 14 and the winding end 120 of the winding 12 is further improved. For further explanation, the lead frame 14 and the winding end 120 of the winding 12 are connected by penetration welding in the portion of the penetration welding spot 18, to ensure that the conduction of the component is still maintained and the risk of structural damage is reduced even with poor contact of solder paste under high-reliability and severe environment.

As shown in FIG. 8, at least one hole 140 is formed on the lead frame 14. In this embodiment, the at least one hole 140 is formed to not penetrate through an edge of the lead frame 14 (i.e., the at least one hole 140 is a closed hole). In another embodiment, the at least one hole 140 may be formed to penetrate through an edge of the lead frame 14 (i.e., the at least one hole 140 is a non-closed hole) and it depends on practical application. When the lead frame 14 is disposed on the outer periphery of the core 10, the at least one hole 140 corresponds to the winding end 120 of the winding 12, such that the winding end 120 of the winding 12 is exposed from the at least one hole 140. In this embodiment, a total area of the winding end 120 may be larger than a total area of the at least one hole 140, such that the winding end 120 may be filled in the at least one hole 140. Accordingly, after the conductive material 16 is disposed in the at least one hole 140, the conductive material 16 may be in contact with the winding end 120 as many as possible, so as to greatly reduce the direct current resistance (DCR). In this embodiment, one hole 140 is formed on the lead frame 14, but the invention is not so limited. In another embodiment, two or more holes 140 may be formed on the lead frame 14 and arranged according to practical application.

Then, step S16 shown in FIG. 2 is performed to dispose a conductive material 16 in the at least one hole 140, such that the conductive material 16 is in direct contact with the winding end 120 of the winding 12, as shown in FIGS. 1 and 8. In this embodiment, the conductive material 16 may be a metal with a resistivity less than 15(10E-8 Ω*m) at room temperature. Furthermore, the conductive material 16 may be one of copper, silver, gold, nickel, tin or the like. Moreover, the conductive material 16 disposed in the at least one hole 140 may be flush with the lead frame 14. Since the conductive material 16 is in direct contact with the winding end 120 of the winding 12, the direct contact between the conductive material 16 and the winding 12 can avoid additional direct current resistance generated by the welding process and then greatly reduce direct current impedance, so as to achieve less power loss in high power application.

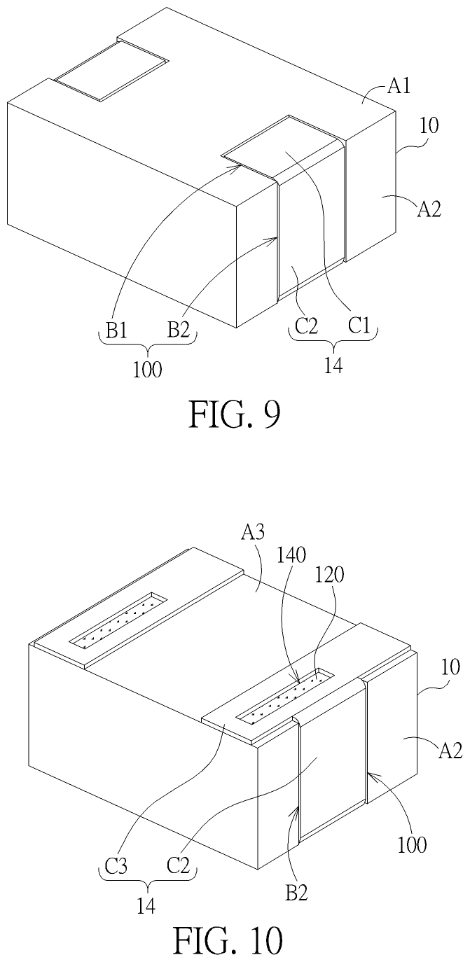

Referring to FIGS. 9 and 10, FIG. 9 is a perspective view illustrating the core 10 and the lead frame 14 according to another embodiment of the invention, and FIG. 10 is a perspective view illustrating the core 10 and the lead frame 14 shown in FIG. 9 from another viewing angle.

As shown in FIGS. 9 and 10, the outer periphery of the core 10 may have a first side A1, a second side A2 and a third side A3, wherein the first side A1 is opposite to the third side A3, and the second side A2 connects the first side A1 and the third side A3. Furthermore, the recess 100 may have a first segment B1 and a second segment B2 formed on the first side A1 and the second side A2 respectively. Still further, the lead frame 14 may have a first section C1, a second section C2 and a third section C3, wherein the first section C1 and the third section C3 are bent from opposite sides of the second section C2. When the lead frame 14 is disposed on the outer periphery of the core 10, the first section C1 is embedded in the first segment B1 of the recess 100 and the second section C2 is embedded in the second segment B2 of the recess 100. In this embodiment, the winding end 120 of the winding 12 mentioned in the above may extend to the third side A3 of the core 10 and the at least one hole 140 may be formed on the third section C3 of the lead frame 14. The third section C3 of the lead frame 14 is disposed on the third side A3 of the core 10, such that the winding end 120 of the winding 12 is exposed from the at least one hole 140.

In this embodiment, the first segment B1 of the recess 100 and the first section C1 of the lead frame 14 may have polygonal shapes corresponding to each other. Thus, the recess 100 is capable of preventing the lead frame 14 from moving leftward and rightward, so as to achieve the performance of normal operation under high reliability.

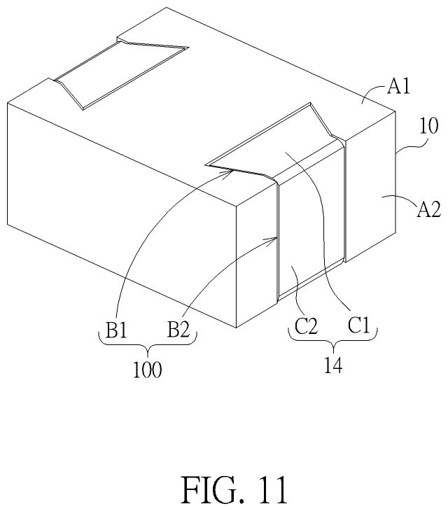

Referring to FIG. 11, FIG. 11 is a perspective view illustrating the core 10 and the lead frame 14 according to another embodiment of the invention.

As shown in FIG. 11, the polygonal shapes of the first segment B1 and the first section C1 may be trapezoidal. Thus, the recess 100 is capable of preventing the lead frame 14 from moving forward, backward, leftward and rightward, so as to achieve the performance of normal operation under high reliability.

As mentioned in the above, the invention forms at least one hole on the lead frame and disposes the lead frame on the outer periphery of the core, such that the winding end of the winding is exposed from the at least one hole. Then, the invention disposes the conductive material in the at least one hole to make the conductive material in direct contact with the winding end of the winding. Compared to conventional design connecting the lead frame and the coil by welding, the direct contact between the conductive material and the winding can avoid additional direct current resistance generated by the welding process and then greatly reduce direct current impedance, so as to achieve less power loss in high power application.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A magnetic component comprising:
a core;
a winding disposed in the core, a winding end of the winding extending to an outer periphery of the core;
a lead frame disposed on the outer periphery of the core, at least one hole being formed on the lead frame and corresponding to the winding end; and
a conductive material disposed in the at least one hole, the conductive material being in contact with the winding end.

2. The magnetic component of claim 1, wherein the at least one hole is formed to penetrate or not penetrate through an edge of the lead frame.

3. The magnetic component of claim 1, wherein a recess is formed on the outer periphery of the core and the lead frame is embedded in the recess.

4. The magnetic component of claim 3, wherein the outer periphery of the core has a first side, a second side and a third side, the first side is opposite to the third side, the second side connects the first side and the third side, the recess has a first segment and a second segment formed on the first side and the second side respectively, the winding end of the winding extends to the third side, the lead frame has a first section, a second section and a third section, the first section and the third section are bent from opposite sides of the second section, the first section is embedded in the first segment of the recess, the second section is embedded in the second segment of the recess, the at least one hole is formed on the third section, and the third section is disposed on the third side.

5. The magnetic component of claim 4, wherein the first segment of the recess and the first section of the lead frame have polygonal shapes corresponding to each other.

6. The magnetic component of claim 5, wherein the polygonal shapes are trapezoidal.

7. The magnetic component of claim 1, wherein a total area of the winding end is larger than a total area of the at least one hole.

8. The magnetic component of claim 1, wherein the lead frame is connected to the winding end of the winding by penetration welding.

9. The magnetic component of claim 1, wherein the conductive material is a metal with a resistivity less than 15(10E-8 Ω*m) at room temperature.

10. The magnetic component of claim 1, wherein the conductive material is one of copper, silver, gold, nickel and tin.

11. The magnetic component of claim 1, wherein the conductive material disposed in the at least one hole is flush with the lead frame.

12. A method of manufacturing a magnetic component comprising steps of:
forming a winding;
disposing the winding in a core and extending a winding end of the winding to an outer periphery of the core;
disposing a lead frame on the outer periphery of the core, wherein at least one hole is formed on the lead frame and corresponds to the winding end; and
disposing a conductive material in the at least one hole, wherein the conductive material is in contact with the winding end.

13. The method of claim 12, wherein a recess is formed on the outer periphery of the core and the lead frame is embedded in the recess.

14. The method of claim 13, wherein the outer periphery of the core has a first side, a second side and a third side, the first side is opposite to the third side, the second side connects the first side and the third side, the recess has a first segment and a second segment formed on the first side and the second side respectively, the winding end of the winding extends to the third side, the lead frame has a first section, a second section and a third section, the first section and the third section are bent from opposite sides of the second section, the first section is embedded in the first segment of the recess, the second section is embedded in the second segment of the recess, the at least one hole is formed on the third section, and the third section is disposed on the third side.

15. The method of claim 12, wherein a total area of the winding end is larger than a total area of the at least one hole.

16. The method of claim 12, wherein the lead frame is connected to the winding end of the winding by penetration welding.

17. The method of claim 12, wherein the conductive material is a metal with a resistivity less than 15(10E-8 Ω*m) at room temperature.

18. The method of claim 12, wherein the conductive material is one of copper, silver, gold, nickel and tin.

19. The method of claim 12, wherein the conductive material disposed in the at least one hole is flush with the lead frame.

20. The method of claim 12, wherein the core comprises a first core member and a second core member, and the step of disposing the winding in a core further comprises steps of:
winding the winding around a pillar of the first core member; and
disposing the pillar with the winding into the second core member.
